(19) United States
(12) Patent Application Publication
(10) Pub. No.: US 2020/0282851 A1
(43) Pub. Date: Sep. 10, 2020

(54) LIQUID COOLED CHARGING CABLE AND CONNECTOR

(71) Applicant: Tesla, Inc., Palo Alto, CA (US)

(72) Inventors: Dino Sasaridis, San Francisco, CA (US); Martin James Sukup, Stanford, CA (US); Colby Hastings, Palo Alto, CA (US); Daniel Wheaton Priestley, Menlo Park, CA (US); Daryl Zalan, San Francisco, CA (US); Dafna Gabriela Szafer, Palo Alto, CA (US); Frank Spiteri, Palo Alto, CA (US)

(21) Appl. No.: 16/810,541

(22) Filed: Mar. 5, 2020

Related U.S. Application Data
(60) Provisional application No. 62/814,620, filed on Mar. 6, 2019.

(51) Int. Cl. B60L 53/302; H02J 7/00; H01B 9/00; H01R 13/50; B60L 53/18

(52) U.S. Cl. CPC B60L 53/302; H02J 7/0045; H01R 2201/26; H01R 13/50; B60L 53/18; H01B 9/00

(57) ABSTRACT

A charging system for an electric vehicle is described. The charging system for an electric vehicle can have a power supply, a charging cable, a connector, and a cooling system. The charging cable can have a coolant conduit routed through the charging cable. The charging cable can also have a coolant return path formed within the charging cable jacket. The cooling system can pump coolant through the coolant conduit and coolant return path to remove heat from the charging cable during a charging process.

### BACKGROUND

### Technical Field

The present invention relates to electric vehicles; and more particularly to a liquid-cooled charging cable and charger for charging of electric vehicles.

### Description of Related Art

The advancement of electric vehicles has created an increased need for charging equipment that delivers electric power. Some such applications (e.g., certain fast-charging vehicle chargers) are designed to work with continuous currents of 100 Amps or more. With the advancement of larger electric vehicles, such as semi-tractor electric vehicles, charging duties have increased. Resultantly, charging cables may be required to service charging at 2,000 Amps or more. Higher current flow in a charging cable results in the generation of more heat, which must be removed to prevent overheating and damage to the charging cable. As a result, the conductors of the charging cables have traditionally been sized larger to match higher current draws, resulting in greater bulk, cost, and difficulty in handling.

### SUMMARY

Various non-limiting aspects of the present disclosure will now be provided to illustrate features of the disclosed apparatus and methods.

In one embodiment, a charging system for an electric vehicle is disclosed. The charging system can include a power supply, a charging cable, and a connector. The charging cable can have a first end and a second end, the first end attached to the power supply. The charging cable can include a jacket along a length of the charging cable; a charging conductor within the jacket; a cooling conduit within the jacket; and a coolant return path within the jacket, but not within a conduit, that at least partially surrounds the charging conductor. The connector can be attached to the second end of the charging cable. The connector can include a chamber for communicating with the coolant conduit, wherein the charging conductor is exposed within the chamber.

In one embodiment, a charging cable for electric car is disclosed. The charging cable can include a conductor having an outer surface; a conduit configured to transport coolant through the charging cable; a jacket encasing the conductor and the conduit; a coolant return path, the coolant return path being defined by the free space within the jacket between the conductor and the conduit; a cable connector configured to connect the charging cable to an electric car; and a coolant return disposed within the cable connector and connected to the conduit, the coolant return having an opening to the coolant return path such that the conduit, coolant return path, and the coolant return are in fluid communication. In various embodiments, the outer surface of the conductor is at least partially exposed in the coolant return path and coolant flowing through the coolant return path contacts at least a part of the outer surface of the conductor.

In one embodiment, a connector for a charging cable for an electric vehicle is disclosed. The charging cable can include a conductor; a charging connector connected to the conductor, the charging connector configured to mate with a charging port; a chamber surrounding at least a part of the charging connector, the chamber having a first opening and a second opening; a conduit configured to transport a fluid, the conduit connected to the first opening such that the chamber and the conduit are in fluid communication; and a structure encasing the chamber, the conduit, the conductor and at least a part of the charging connector, the structure forming a pathway that is defined by the free space between the chamber, the conduit, the conductor, and at least a part of the charging connector, the pathway being connected to the second opening such that the chamber, the conduit, and the pathway are in fluid communication. In various embodiments, fluid flowing within the chamber can contact at least a part of the charging connector.

### BRIEF DESCRIPTION OF THE SEVERAL VIEWS OF THE DRAWINGS

FIG. 1 illustrates the basic components of a battery powered electric vehicle.

FIG. 2 illustrates the basic components of a charging system according to a described embodiment.

FIG. 3 is a cross-sectional diagrammatic view of a charging cable according to a described embodiment.

FIG. 4 is a cross-sectional diagrammatic view of a connector according to a described embodiment.

FIG. 5 is a diagrammatic perspective view of a charging cable and connector according to a described embodiment.

FIG. 6 is a first diagrammatic perspective cut-away view of a charging cable and connector according to a described embodiment.

FIG. 7 is a second diagrammatic perspective cut-away view of a charging cable and connector according to a described embodiment.

FIG. 8 is an end view of a connector according to a described embodiment.

FIG. 9 is a diagrammatic perspective view of a charging cable and connector in a near mating position with a charging port according to a described embodiment.

### DETAILED DESCRIPTION OF THE DISCLOSURE

The present disclosure describes examples of systems and techniques for cooling charging cables. A charging cable is a cable that can be used to transport or deliver electric power from one system to another. For example, a charging cable can be used to deliver electric power from a charging station to an electric vehicle such as a car or semi-truck. When the charging system delivers electric power at a high current (e.g. 100 Amps or more), the current flow within the charging cable can generate high amounts of heat. In some situations, this heat can cause several issues. For example, the heat can damage components of the charging system or cable and can make handling the heated cable very difficult or dangerous for a user. In charging systems that deliver power at even higher currents (e.g. 1000 Amps or more), removing the heat from the charging cables can be vital to the safety of the operators and to the lifespan of the components involved in the charging system.

To remove heat from the charging cable, a cooling system can be implemented into the charging process. For example, a charging cable for an electric vehicle can be cooled by a liquid cooled system. Using liquid cooling to remove heat from a charging cable can provide several advantages. For example, using liquid cooling can allow for a higher current to be fed through the charging cable, as the effects of the heat are removed or greatly reduced. Additionally, using liquid cooling can allow for a more convenient cable design. With the effects of the heat being removed or greatly reduced, bulky and large cables are no longer needed to protect the equipment and user from the generated heat. Thus, the charging cable can be a lighter cable, thinner cable, and/or a more flexible cable.

One embodiment is an electric vehicle charging cable that includes a non-conductive liquid heat transfer medium. The charging cable may include a cooling conduit for transferring the coolant or liquid heat transfer media from a cooling system near a charging base to a connector which interfaces with a charging port on the electric vehicle. In this embodiment the connector includes an internal chamber adjacent the terminal ends of a pair of charging conductors which carry the electric current through the charging cable. In use, the non-conductive liquid heat transfer media exits the cooling conduit near the internal chamber and then contacts one or both charging conductors to remove heat from those terminal ends of the conductors within the chamber. The size and the dimensions of the internal chamber are designed to have a fairly small hydrodynamic diameter such that a relatively rapid flow of the liquid heat transfer media will interact with the charging conductors.

In one embodiment, the charging cable comprises an outer jacket or shell that is impermeable to liquid and acts to contain the liquid heat transfer media as it exits the internal chamber and flows back towards the cooling system and charging base. As the media flows along the internal spaces within the charging cable and jacket, the media can remove additional heat from the conductors that traverse the charging cable from the base to the connectors. In this embodiment, the media does not flow within a conduit as it returns to the charging base, but instead flows along all the internal spaces within the outer jacket of the charging cable.

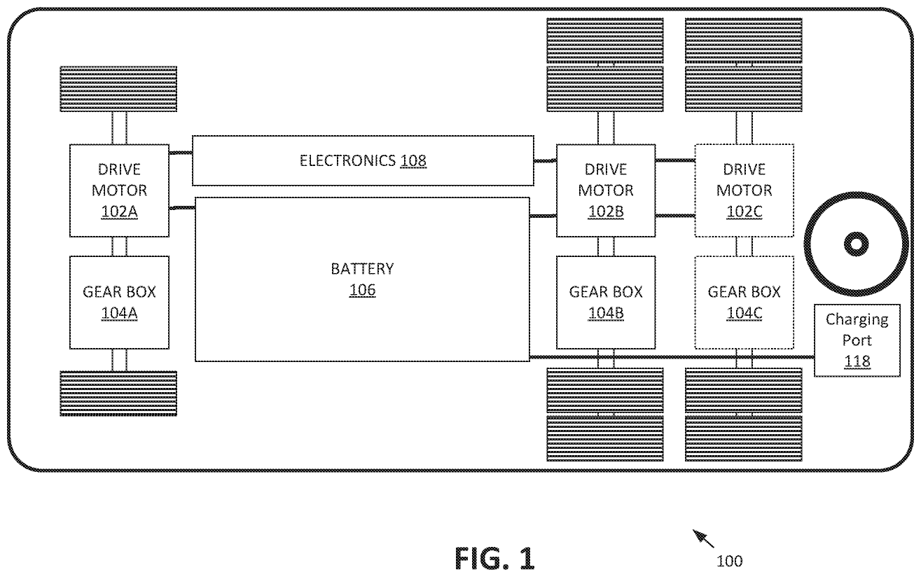

FIG. 1 illustrates the basic components of a battery powered electric vehicle (e.g. electric vehicle) 100. The electric vehicle 100 includes at least one drive motor (e.g. traction motor) 102A, 102B and/or 102C, at least one gear box 104A, 104B, and/or 104C coupled to a corresponding drive motor 102A, 102B, and/or 102C, a battery 106 and electronics 108. Generally, the battery 106 provides electricity to the electronics 108 of the electric vehicle 100 and to the drive motors 102A, 102B and/or 102C to propel the electric vehicle 100 using the drive motors 102A, 102B and/or 102C. The electric vehicle can include a charging port 118, which can be used to receive energy to charge/recharge the battery 106. In some embodiments, the electric vehicle 100 includes a number of other components that are not described herein. While the construct of the electric vehicle 100 of FIG. 1 is shown to have ten wheels, differing electric vehicles may have fewer or more than ten wheels. Further, differing types of electric vehicles 100 may incorporate the concepts described herein.

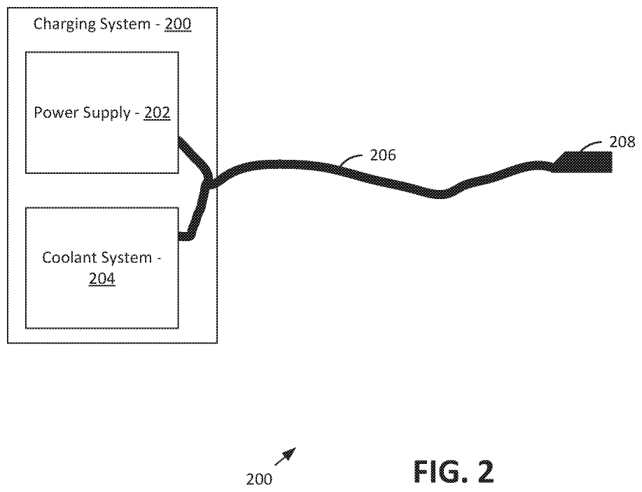

FIG. 2 illustrates a schematic of the basic components of a charging system according to a described embodiment. The charging system 200 includes a power supply 202, a coolant system 204, a charging cable 206 and a connector 208. The charging cable 206 has a first end and a second end, the first end attached to the power supply 202. In some embodiments, the charging cable 206 can include a j acket, charging conductors within the jacket, a pair of signaling conductors within the jacket, a cooling conduit within the jacket, and a coolant return path within the jacket. In some embodiments, the coolant return path within the jack can at least partially surround the charging conductors, the pair of signaling conductors, and the cooling conduit. The connector 208 attaches to the second end of the charging cable 206. In some embodiments, the connector 208 can include a support structure, charging connectors within the support structure that electrically couple to the charging conductors, a pair of signaling connectors within the support structure that electrically couple to the signaling conductors, and a coolant return within the support structure that couples between the cooling conduit and the coolant return path.

The coolant system 204 provides coolant to the charging cable 206 and receives heated coolant from the charging cable 206. The coolant system 204 disperses heat within the received coolant by dispersing heat to the ambient via a radiator, a refrigerator system or process, or a combination of both. In other embodiments, the coolant system 204 can disperse the heat of the coolant through other means. The coolant can be any coolant that resists electrical shortages while still providing beneficial heat transfer and thermal properties. For example, the coolant can be a dielectric oil, which is non-conductive and can resist electrical shorts while providing beneficial thermal properties. In various embodiments, a pump can be connected with the coolant system 204. The pump can be directly connected to the charging cable 206 (e.g. with no intervening parts), or it can be indirectly connected to the charging cable 206 (e.g. with at least one part between the charging cable 206 and the pump). The pump can be used to pump coolant through the system. In some embodiments, the charging system 200 provides in excess of 2000 Amps of charge at 1500 Volts, for example, to support both as long-haul applications where DC fast charging is required (1-2 MW) as well as overnight DC charging (100 kW).

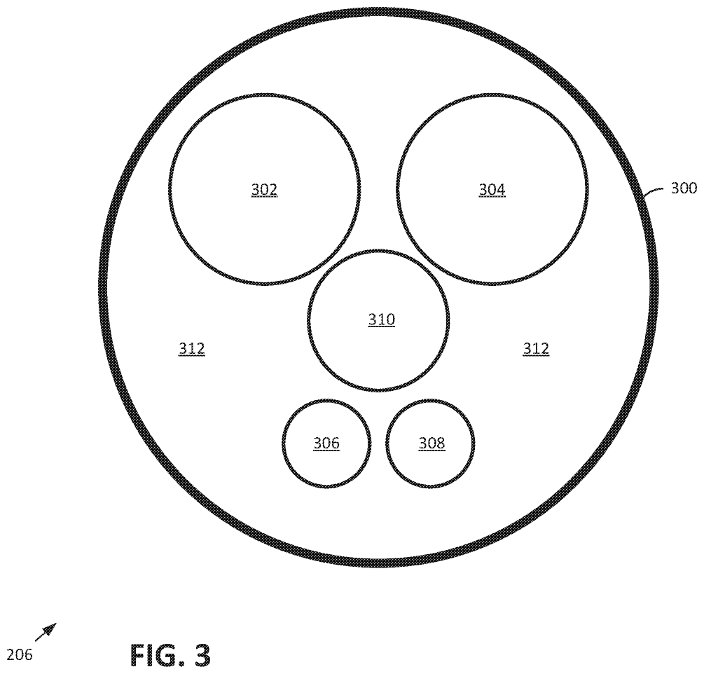

FIG. 3 is a cross-sectional diagrammatic view of a charging cable according to a described embodiment. The charging cable 206 includes a jacket 300, charging conductors 302 and 304 within the jacket, a pair of signaling conductors 306 and 308 within the jacket, a cooling conduit 310 within the jacket 300, and a coolant return path 312 within the jacket 300. In various embodiments, the jacket 300 can be made from a material that is impermeable to a coolant and can resist corrosion from a coolant. In some embodiments, the jacket 300 can be made from rubber, a rubber substitute, plastic, a separate material, or a combination of materials. In some embodiments, the coolant return path 312 is not a separate conduit within the jacket 300, but is instead the free space within the jacket 300. The free space in the jacket 300 can be defined as the space between the charging conductors 302, 304, the signaling conductors, 306, 308, the cooling conduit 310, and within the jacket 300. The coolant return path 312 can at least partially surround the charging conductors 302 and 304, the pair of signaling conductors 306 and 308, and the cooling conduit 310. In some embodiments, coolant flowing within the coolant return path 312 can freely flow within the jacket 300.

In various embodiments, the charging conductors 302, 304, the signaling conductors 306, 308, and the cooling conduit 310 are spaced apart from each other within the jacket 300. Spacing apart these components within the jacket 300 creates free space that between these components within the jacket 300. In some embodiments, coolant originates from the cooling system 204 and flows through the cooling conduit 310. This coolant can flow out of the cooling conduit 310 through a coolant return and flow into the coolant return path 312. The coolant flowing through the coolant return path 312 can return to the coolant system 204 where the coolant can disperse its captured heat and be returned back through the coolant conduit 310. In various embodiments, a pump is used to pump the coolant through the cooling conduit 310, the coolant return path 312, and the coolant system 204. In some embodiments, the charging conductors 302, 304 and the signaling conductors, 306, 308 do not have a thermal barrier so the coolant within the coolant return path 312 can directly contact the charging conductors 302, 304 and the signaling conductors, 306, 308. In some embodiments, the coolant can contact the outer surface of the charging conductors 302, 304 and the signaling conductors 306, 308.

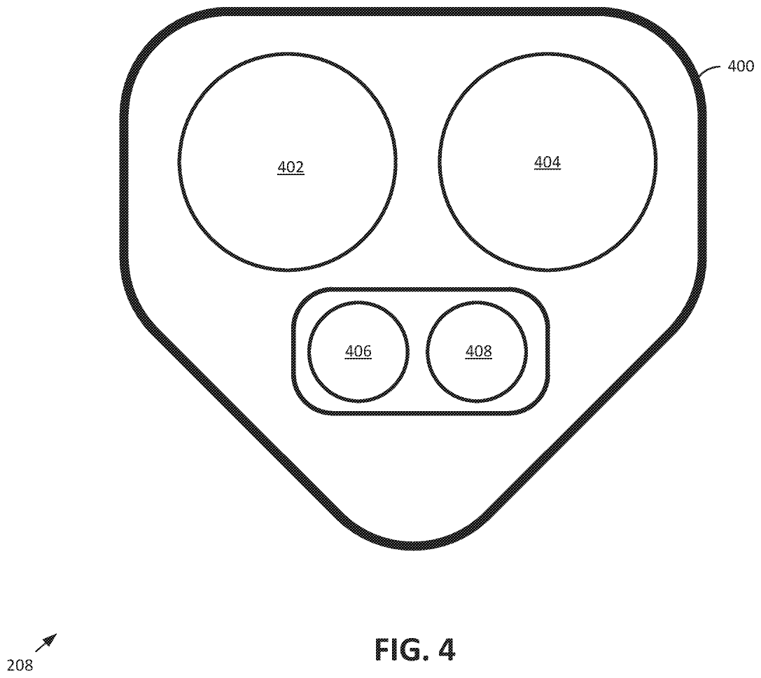

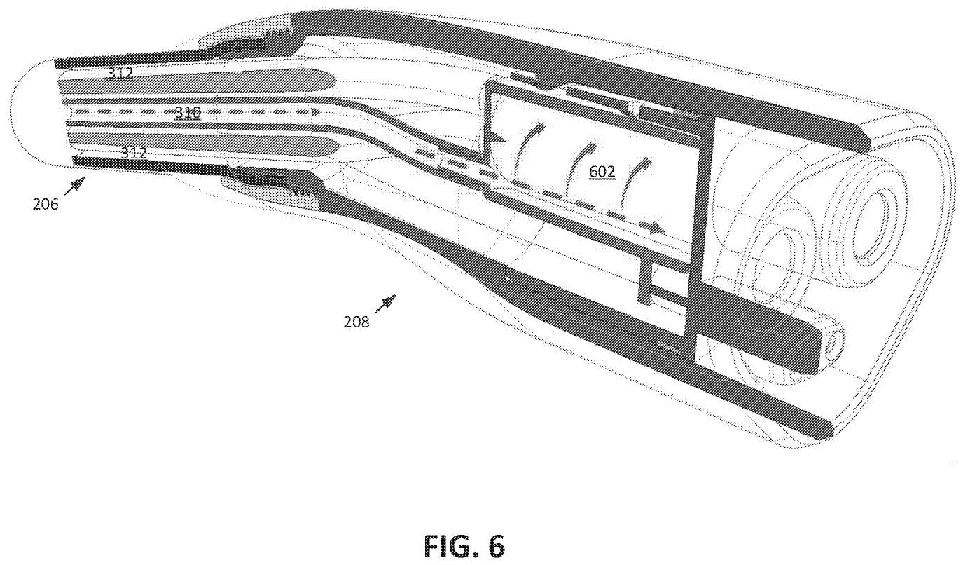

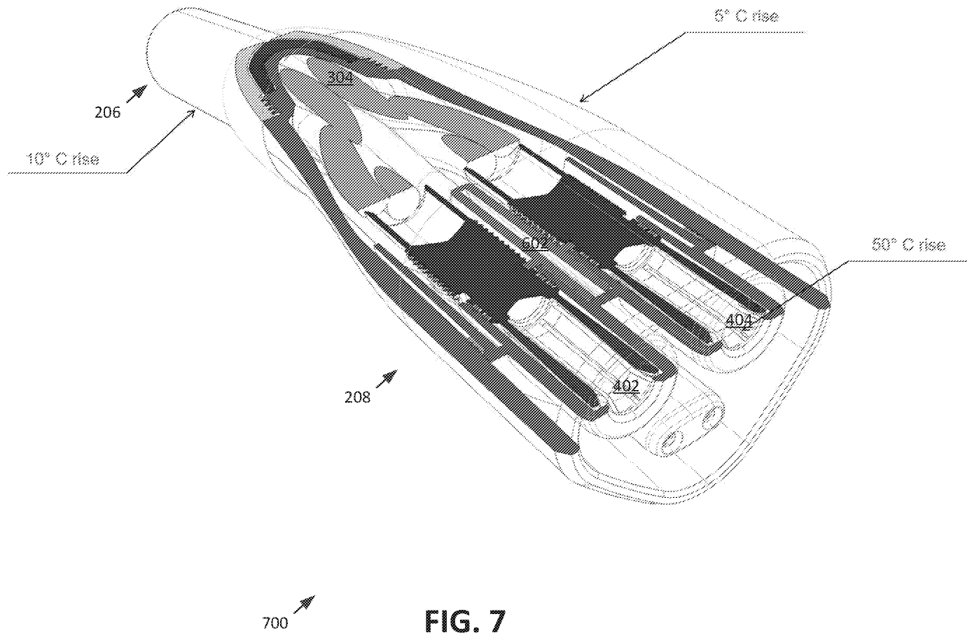

FIG. 4 is a cross-sectional diagrammatic view of a connector according to a described embodiment. The connector 208 attaches to the second end of the charging cable 206 and includes a support structure 400, charging connectors 402 and 404 within the support structure 400 that electrically couple to the charging conductors 302 and 304, and a pair of signaling connectors 406 and 408 within the support structure 400 that electrically couple to the signaling conductors 306 and 308. In some embodiments, the connector 208 can include a coolant return (as shown in FIGS. 6 and 7) within the support structure 400 that couples between the cooling conduit 310 and the coolant return path 312. The connector 208 can mate with a charging port 118 of an electric vehicle. For example, the substantially triangular cross section of the connector can be used to mate with a similarly shaped female charging port 118 on the electric vehicle 100.

Referring to both FIGS. 3 and 4, the charging conductors 302 and 304 and the charging connectors 402 and 404 are constructed of a conductive metal with insulative surroundings. The conductive material may be copper, aluminum, an alloy, or another metal. The charging conductors 302 and 304 as well as the charging connectors 402 and 404 have sufficient sizing to carry 2000 amps of direct current or more. Because of the coolant flowing through the charging cable 200, the charging conductors 302, 304 and the charging connectors 402, 404 are actively cooled. This active cooling leads to the connector 208 to not overheat, which allows for the support structure 400 to maintain a safe handling temperature. As a result, the connector 208 may be handled easily without injury to the handler.

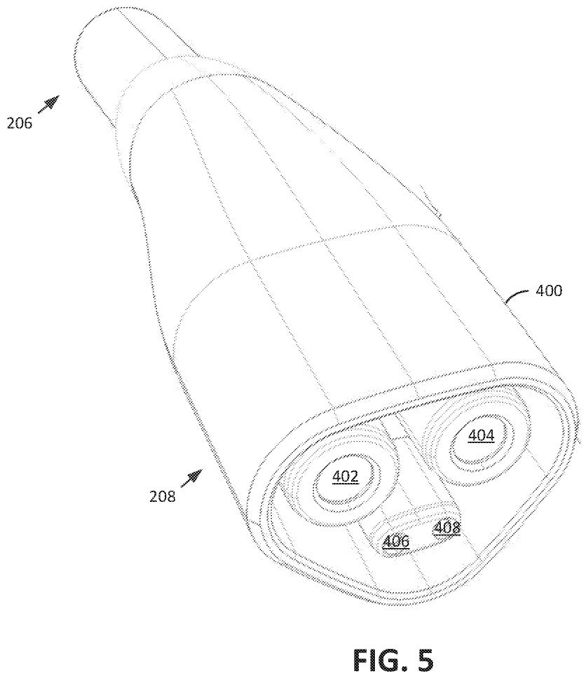

FIG. 5 is a diagrammatic perspective view of a charging cable and connector according to a described embodiment. Shown are the charging cable 206 and the connector 208, including the support structure 400, the charging connectors 402 and 404, and signaling connectors 406 and 408.

FIG. 6 is a first diagrammatic perspective cut-away view of a charging cable and connector according to a described embodiment. Identified in FIG. 6 is the coolant return 602 that receives coolant from the cooling conduit 310. The coolant return 602 can connect with the cooling conduit 310 and be in fluid communication with cooling conduit 310 (e.g. the fluid can flow from the cooling conduit 310 into the coolant return 602). The coolant return 602 circulates the coolant about the charging connectors 402 and 404 and supports the return of the coolant via the coolant return path 312 of the cable 206. In some embodiments, the coolant return 602 can form an open ended chamber that partially surrounds charging connectors 402, 404. In various embodiments, the coolant return 602 forms a chamber that partially surrounds the charging connectors 402, 404 and the charging conductors 302, 304. In other embodiments, the coolant return 602 forms a chamber that partially surrounds the charging conductors 302, 304. The chamber can have a front wall, a top wall, a back wall, a bottom wall, and sidewalls. The front wall can prevent the coolant from escaping out of the front end the connector 208. The walls of the chamber can direct or route the coolant to flow over and around the charging conductors 302, 304 or the charging connectors 402, 404. In some embodiments, the size and shape of the chamber can determine the flow characteristics of coolant flowing into the chamber. For example, a chamber with a small hydrodynamic diameter (e.g. a diameter that is about half or smaller than half of the diameter of the jacket 300 or connector 208) can have a faster flow rate of coolant than chamber with a large hydrodynamic diameter (e.g. a diameter that is larger than about half the diameter of the jacket 300 or connector 208). The hydrodynamic diameter of the chamber can be a variety of sizes. For example, the chamber can have a hydrodynamic diameter that is about one-third, one-fourth, one-sixth, one-eighth, or one-tenth the diameter of the jacket 300. In other embodiments, the chamber can have a hydrodynamic diameter that is about one-third, one-fourth, one-sixth, one-eighth, or one-tenth the diameter of the connector 208. The chamber can have an open end near the back or sides of the chamber. In various embodiments, the open end can be located at other portions of the coolant return 602 and along multiple locations of the coolant return 602. This open end can connect with the coolant return path 312 and form a pathway that opens into the coolant return path 312 so the coolant return 602 can be in fluid communication with the coolant return path 312. In some embodiments, the chamber of the coolant return can have a first opening that is in communication with the coolant conduit 310 and a second opening that is in communication with the coolant return path. In various embodiments, coolant flowing into the coolant return 612 from the coolant conduit 310 can flow over the charging conductors 302, 304 or charging connectors 402, 404 and exit the coolant return 612 into the coolant return path 312. In some embodiments, the coolant return 602 is sized and shaped to prevent coolant from flowing over the signaling connectors 406, 408. In other embodiments, the coolant return is sized and shaped so as to allow coolant to flow over at least a part of the signaling connectors 406, 408. In some embodiments, the pathway formed in part by the open end of the coolant return 602 can also include the free space between the chamber, the cooling conduit 310, the charging connectors 402, 404, the signaling connectors 406, 408, the charging conductors 302, 304, and the signaling conductors 306, 308 within the support structure 400. In some embodiments, the coolant return 602 can dump coolant directly over charging conductors 302, 304 and the charging connectors 402, 404. The charging conductors 302, 304 and the charging connectors 402, 404 can be exposed so there is no thermal barrier between the coolant, the charging conductors 302, 304, and the charging connectors 402, 404.

FIG. 7 is a second diagrammatic perspective cut-away view of a charging cable and connector according to a described embodiment. The coolant return 602 is showing its relationship to the charging connectors 402 and 404 and the charging conductors 302 and 304. As shown in FIG. 7, the coolant return 602 can partially be positioned in between the charging connectors 402 and 404. The coolant return 602 can also have sidewalls that are positioned outside of the charging connectors 402 and 404. The coolant return 602 can have an open end that opens to coolant return path 312 of the charging cable. With the structure of the described embodiment, the charging connectors 402 and 404 may have a 50 degree C. rise in temperature while the connector 208 only has a 5 degree C. external rise in temperature and the charging cable 206 only has a 10 degree C. external rise in temperature. The relatively low temperature rise of the connector 208 and the charging cable 206 allows for handling when still heated after charging a vehicle. Using advanced plastics and/or active cooling, which is achieved by pumping coolant through the cable 206, connector 208, and a cooling system 204, allows for higher internal socket temperatures.

The connector 208 is constructed such that the signaling connectors 406 and 408 disengage from a charging port 118 prior to the charging connectors 402 and 404 disengaging from the charging port 118. This structure can be achieved by utilizing signaling connectors 406, 408 that are longer than the charging connectors 402, 404. In some embodiments, the signaling connectors 406, 408 may extend further out from the connector 208 than the charging connectors 402, 404. In various embodiments, the design of the charging port 118 will permit the signaling connectors 406, 408 to disengage from the charging port 118 prior to the charging connectors 402, 404 from disengaging. With this structure, the charging system 200 may cut off power based upon detected loss of signaling prior to disengagement of the charging connectors 402 and 404 from the charging port 118. A CPU can be connected to the charging system 200. The CPU can determine when a loss of signaling is present and send a command to cut off the power. By having only two signaling connectors 406 and 408 (as well as only two signal conductors 306 and 308 of the charging cable 206), the signaling connectors 406 and 408 occupy less of the cross sectional area of the connector 208 and charging cable 206.

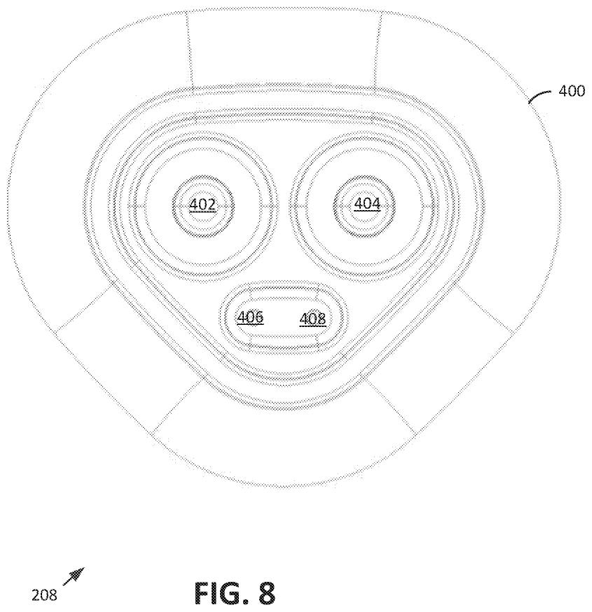

FIG. 8 is an end view of a connector 208 according to a described embodiment. The end view 800 of FIG. 8 is similar to the view of FIG. 3 and shows the support structure 400, the charging connectors 402 and 404 within the support structure 400, and a pair of signaling connectors 406 and 408 within the support structure 400.

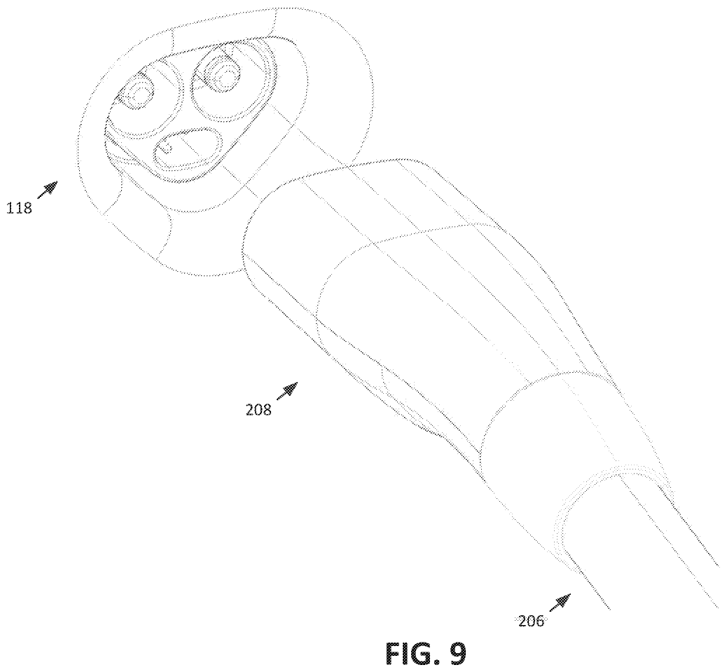

FIG. 9 is a diagrammatic perspective view of a charging cable and connector in a near mating position with a charging port according to a described embodiment. The charging port 118 has a structure complementary to the connector 208 to receive the components thereof (as shown in FIG. 8). Thus, the charging port 118 has a form factor complimentary to the form factor of the connector 208.

An example method of using the charging will now be described. A user can connect a charging system 200 to an electric vehicle 100. The user can connect the charging system 200 to the electric vehicle 100 by connecting the connector 208 of the charging cable 206 to the electric vehicle's 100 charging port 118. When the connector 208 is connected to the charging port 118, the signaling connectors 406, 408 electrically connect with the complimentary signaling receivers on the charging port 118. Additionally, the charging connectors 402, 404 electrically connect with the complimentary charging receivers on the charging port 118. Once the connector 208 is connected to the charging port 118, data can be sent from the electric vehicle to the charging system through the signaling connectors 406, 408 and signaling conductors 306, 308. Additionally, electric power can be sent from the power supply 202 of the charging system 200 to the electric vehicle 100 by sending the power through the charging conductors 302, 304 and the charging connectors 402, 404. As the power supply 202 charges the battery 106 of the electric vehicle 100, coolant from the coolant system 204 can be pumped through the charging cable 206 and connector 208. The coolant can enter into the charging cable 206 through the coolant conduit 310. The coolant conduit 310 can transport the coolant from one end of the charging cable 206 to the connector 208. The coolant conduit 310 can be connected to and in fluid communication with the coolant return 602. As coolant enters into the coolant return 602, the coolant is routed over the charging connectors 402, 404 by the coolant return 602. After the coolant is routed over the charging connectors 402, 404, the coolant exits the coolant return 602 and flows into the coolant return path 312. The coolant can fill the free space within the jacket 300 created by the spacing between the charging conductors 302, 304, the signaling conductors 306, 308, and the coolant conduit 310. The coolant within the coolant return path 312 can travel back to coolant system 204, where heated is removed from the coolant. The heat can be removed from the coolant through a radiator, a refrigeration process, or other heat removal process. Once heat is removed from the coolant, the coolant can be pumped back through the coolant conduit 310. The coolant can be cycled through the coolant system 204, charging cable 206, and connector 208 repeatedly and throughout the duration of the charging process. Once the user disconnects the connector 208 from the charging port 118, the charging system 200 can detect a loss of signal from the signaling conductors 306, 308 and the signaling connectors 406, 408.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed system, method, and computer program product. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent toone skilled in the art after having the benefit of this description of the disclosure.

Routines, methods, steps, operations, or portions thereof described herein may be implemented through electronics, e.g., one or more processors, using software and firmware instructions. A “processor” includes any hardware system, hardware mechanism or hardware component that processes data, signals or other information. A processor can include a system with a central processing unit, multiple processing units, dedicated circuitry for achieving functionality, or other systems. Some embodiments may be implemented by using software programming or code in one or more digital computers or processors, by using application specific integrated circuits (ASICs), programmable logic devices, field programmable gate arrays (FPGAs), optical, chemical, biological, quantum or nano-engineered systems, components and mechanisms. Based on the disclosure and teachings representatively provided herein, a person skilled in the art will appreciate other ways or methods to implement the invention.

As used herein, the terms “comprises,” “comprising,” “includes,” “including,” “has,” “having” or any contextual variants thereof, are intended to cover a non-exclusive inclusion. For example, a process, product, article, or apparatus that comprises a list of elements is not necessarily limited to only those elements, but may include other elements not expressly listed or inherent to such process, product, article, or apparatus. Further, unless expressly stated to the contrary, “or” refers to an inclusive or and not to an exclusive or. For example, a condition “A or B” is satisfied by any one of the following: A is true (or present) and B is false (or not present), A is false (or not present) and B is true (or present), and both A and B is true (or present).

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, reversed, or otherwise controlled by another process.

It will also be appreciated that one or more of the elements depicted m the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

What is claimed is:

1. A charging system for an electric vehicle comprising:
a power supply;
a charging cable having a first end and a second end, the first end attached to the power supply, the charging cable comprising:
a jacket along a length of the charging cable;
a charging conductor within the jacket;
a cooling conduit within the jacket; and
a coolant return path within the jacket, but not within a conduit, that at least partially surrounds the charging conductor; and
a connector attached to the second end of the charging cable, the connector comprising a chamber communicating with the coolant conduit, wherein the charging conductor is exposed within the chamber.

2. The charging system of claim 1, further comprising a cooling system connected to the charging cable, the cooling system being configured to pump a coolant through the cooling conduit in the charging cable.

3. The charging system of claim 2, wherein the cooling system is configured to remove heat from the coolant through a refrigeration process.

4. The charging system of claim 2, wherein the coolant directly contacts the charging conductor within the chamber.

5. The charging system of claim 2, wherein the coolant is a dielectric oil.

6. The charging system of claim 1, wherein the charging conductor is sized to carry at least 2000 amps of direct current.

7. The charging system of claim 1, wherein the coolant conduit does not contact the charging conductor.

8. The charging system of claim 1, wherein the charging conductor does not contain a thermal barrier.

9. The charging system of claim 1, wherein the jacket is made from a plastic material.

10. A charging cable for electric car comprising:
a conductor having an outer surface;
a conduit configured to transport coolant through the charging cable;
a jacket encasing the conductor and the conduit;
a coolant return path, the coolant return path being defined by the free space within the jacket between the conductor and the conduit;
a cable connector configured to connect the charging cable to an electric car; and
a coolant return disposed within the cable connector and connected to the conduit, the coolant return having an opening to the coolant return path such that the conduit, coolant return path, and the coolant return are in fluid communication;
wherein the outer surface of the conductor is at least partially exposed in the coolant return path, and
wherein coolant flowing through the coolant return path contacts at least a part of the outer surface of the conductor.

11. The charging system of claim 10, wherein the conductor is sized to carry at least 2000 amps of direct current.

12. The charging system of claim 10, wherein at least a part of the outer surface of the conductor is directly exposed within the coolant return path.

13. The charging system of claim 10, wherein the conductor does not contain a thermal barrier.

14. The charging system of claim 10, wherein the charging connector does not contain a thermal barrier.

15. The charging system of claim 10, wherein the conduit does not contact the charging conductor.

16. A connector for a charging cable for an electric vehicle comprising:
a conductor;
a charging connector connected to the conductor, the charging connector configured to mate with a charging port;
a chamber surrounding at least a part of the charging connector, the chamber having a first opening and a second opening;
a conduit configured to transport a fluid, the conduit connected to the first opening such that the chamber and the conduit are in fluid communication; and
a structure encasing the chamber, the conduit, the conductor and at least a part of the charging connector, the structure forming a pathway that is defined by the free space between the chamber, the conduit, the conductor, and at least a part of the charging connector, the pathway being connected to the second opening such that the chamber, the conduit, and the pathway are in fluid communication;
wherein fluid flowing within the chamber can contact at least a part of the charging connector.

17. The charging system of claim 16, wherein the conductor is sized to carry at least 2000 amps of direct current.

18. The charging system of claim 16, wherein the conduit does not contact the conductor.

19. The charging system of claim 16, wherein the conductor does not contain a thermal barrier.

20. The charging system of claim 16, wherein the charging connector does not contain a thermal barrier.
